(19) United States
(12) Patent Application Publication
(10) Pub. No.: US 2013/0343887 A1
(43) Pub. Date: Dec. 26, 2013

(54) Variable Speed Friction Wheel Drive Train for Wind Turbines

(71) Applicants: Richard A. Himmelmann, Beloit, WI (US); Stephen E. Tongue, Hampden, MA (US)

(72) Inventors: Richard A. Himmelmann, Beloit, WI (US); Stephen E. Tongue, Hampden, MA (US)

(21) Appl. No.: 13/532,458

(22) Filed: Jun. 25, 2012

(51) Int. Cl. F03D 11/02; F16H 15/04; F16H 15/22; F16H 15/02

(52) U.S. Cl. 416/1; 476/67; 476/47; 476/50; 416/170 R

(57) ABSTRACT

A variable speed ratio speed increaser drive train for a wind turbine is disclosed. The drive train may include at least one drive wheel adapted to receive mechanical energy from a main shaft of the wind turbine and capable of rotating at a variable input rotational speed and at least one driven wheel in at least indirect contact with the at least one drive wheel, the at least one driven wheel capable of at least indirectly translating against the at least one drive wheel to vary a speed ratio of the drive train to provide a constant output rotational speed.

### FIELD OF THE DISCLOSURE

The present disclosure relates generally to wind turbines and, more particularly, relates to variable speed friction wheel drive trains for wind turbines.

### BACKGROUND OF THE DISCLOSURE

A utility-scale wind turbine typically includes a set of two or three large rotor blades mounted to a rotor hub. The rotor blades and the rotor hub together are referred to as the rotor. The rotor blades aerodynamically interact with the wind and create lift and drag, which is then translated into a driving torque by the rotor hub. The rotor is attached to and drives a main shaft, which in turn is operatively connected via a drive train to a generator or a set of generators that produce electric power. The main shaft, the drive train and the generator(s) are all situated within a nacelle, which is situated on top of a tower.

Many types of drive trains are known for connecting the main shaft to the generator(s). One type of drive train uses various designs and types of speed increasing gearboxes to connect the main shaft to the generator(s). Typically, the gearboxes include one or more stages of gears and a large housing, wherein the stages increase the rotor speed to a speed that is more desirable for driving the generator(s). While effective, large forces translated through the gearbox can deflect the gearbox housing and components therein and displace the large gears an appreciable amount so that the alignment of meshing gear teeth can suffer. When operating with misaligned gear teeth, the meshing teeth can be damaged, resulting in a reduced lifespan. The large size of these gearboxes and the extreme loads handled by them (including transient over torque conditions) make them even more susceptible to deflections and resultant premature wear and damage, such as gear pitting. Furthermore, maintenance and/or replacement of parts of damaged gearboxes may not only be difficult and expensive, it may require entire gearboxes to be lifted down from the wind turbine.

To counteract the disadvantages of traditional gearboxes, some wind turbines have started employing friction wheel drive trains. Friction wheel drive trains replace conventional gearboxes in a wind turbine and include at least one drive wheel and at least one driven wheel as speed increasing stages that drive the generator(s) connected thereto. Motion in friction wheel drive trains is transmitted from the drive wheel to the driven wheel through frictional forces. While the friction wheel drive train alleviates at least some of the problems associated with conventional gearboxes, the friction wheel drive trains that are employed currently are constant speed ratio drive trains.

With such constant speed ratio drive train friction wheel systems, the rotational speed of the generator(s) connected to the driven wheel of the friction wheel drive train varies as the wind turbine rotational speed varies (in variable speed wind turbines). As the speed of the generator(s) varies, the output frequency of the generator(s) varies as well. In order to transmit the generator power to a grid, a fixed frequency alternating current (AC) wave form must be produced by the generator(s) and synchronized to the grid. With variable speed wind turbines employing constant speed ratio friction wheel drive trains and variable frequency generator(s), a fixed output frequency of the generator(s) is typically accomplished by first rectifying the generator output power (from AC) to direct current (DC) power. This DC power is then inverted to create a fixed AC wave form. The power electronic equipment utilized to rectify and invert the wind turbine generator output power is not only expensive, it is also inefficient and unreliable. An alternative to using variable speed wind turbines is a fixed rotational speed wind turbine in which the rotational speed of the rotor (and therefore the generators) does not change. However, fixed rotational speed wind turbines are not very desirable, given specially that they are aerodynamically less efficient than variable speed wind turbines.

Accordingly, it would be beneficial if a friction wheel drive train were developed that could alleviate at least some of the disadvantages of conventional gearboxes while providing a capability to regulate an output frequency of variable frequency generator(s) and synchronize the generator(s) with the grid without any special power electronic component in variable speed wind turbines.

### SUMMARY OF THE DISCLOSURE

In accordance with one aspect of the present disclosure, a drive train for a wind turbine is disclosed. The drive train may include at least one drive wheel adapted to receive mechanical energy from a main shaft of a wind turbine and capable of rotating at a variable input rotational speed and at least one driven wheel in at least indirect contact with the at least one drive wheel, the at least one driven wheel capable of at least indirectly translating against the at least one drive wheel to vary a speed ratio of the drive train to provide a constant output rotational speed.

In accordance with another aspect of the present disclosure, a wind turbine is disclosed. The wind turbine may include a hub, a plurality of blades radially extending from the hub and a main shaft rotating with the hub. The wind turbine may also include a drive train comprising (a) at least one drive wheel mounted to the main shaft and rotating at a variable input rotational speed; and (b) at least one driven wheel in at least indirect contact with the at least one drive wheel, the at least one driven wheel capable of providing a constant output rotational speed by varying a speed ratio of the drive train.

In accordance with yet another aspect of the present disclosure, a method of varying a speed ratio of a drive train for a wind turbine is disclosed. The method may include providing a drive train having (a) at least one drive wheel mounted to a main shaft of a wind turbine and rotating at a variable input rotational speed; and (b) at least one driven wheel in at least indirect contact with the at least one drive wheel, the at least one driven wheel capable of providing a constant output rotational speed. The method may also include translating the at least one driven wheel at least indirectly against a surface of the at least one drive wheel and changing a contact location between the at least one drive wheel and the at least one driven wheel during the translating step to vary the speed ratio of the drive train.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIGS. 2 and 3 show a first embodiment of a variable speed friction wheel drive train for use within the wind turbine of FIG. 1;

FIGS. 4 and 5 show a second embodiment of the variable speed friction wheel drive train for use within the wind turbine of FIG. 1;

FIGS. 6 and 7 show a third embodiment of the variable speed friction wheel drive train for use within the wind turbine of FIG. 1;

FIGS. 8, and 9 show a fourth embodiment of the variable speed friction wheel drive train for use within the wind turbine of FIG. 1;

FIGS. 8A and 9A show cross sectional views in cut-away of FIGS. 8 and 9, respectively; and

FIGS. 10 and 11 show a fifth embodiment of the variable speed friction wheel drive train for use within the wind turbine of FIG. 1.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

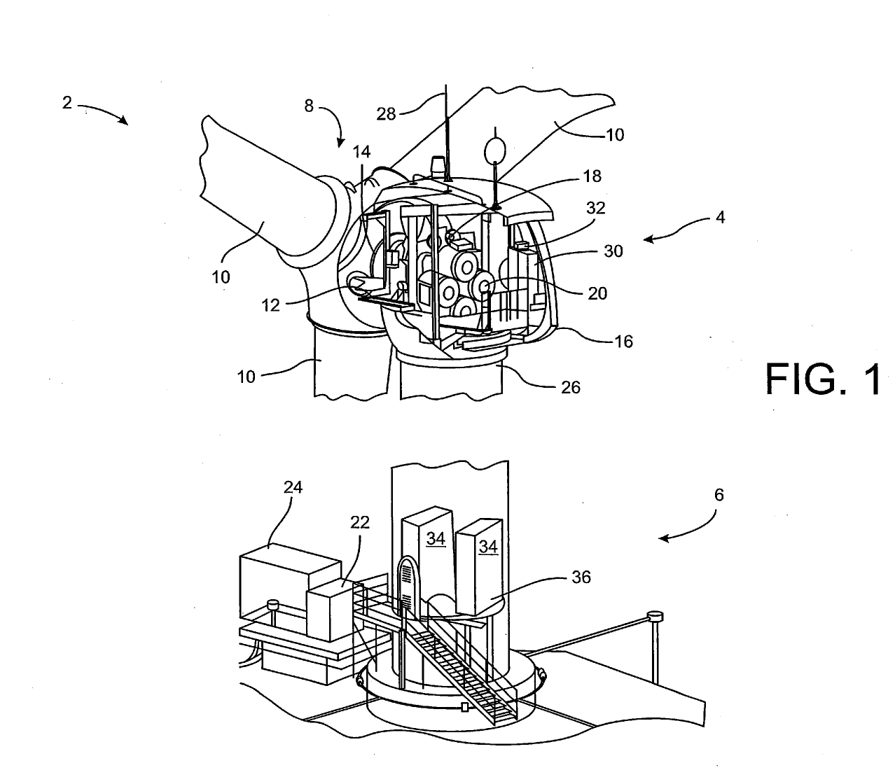

Referring now to FIG. 1, an exemplary wind turbine 2 is shown, in accordance with at least some embodiments of the present disclosure. While all the components of the wind turbine have not been shown and/or described, a typical wind turbine may include an up tower section 4 and a down tower section 6. The up tower section 4 may include a rotor 8, which in turn may include a plurality of blades 10 connected to a hub 12. The blades 10 may rotate with wind energy and the rotor 8 may transfer that energy to a main shaft 14 situated within a nacelle 16. The nacelle 16 may additionally include a drive train 18 (e.g., a friction wheel drive train), which may connect the main shaft 14 on one end to one or more generators 20 on the other end. The generators 20 may generate power, which may be transmitted from the up tower section 4 through the down tower section 6 to a power distribution panel (PDP) 22 and a pad mount transformer (PMT) 24 for transmission to a grid (not shown). The PDP 22 and the PMT 24 may also provide electrical power from the grid to the wind turbine for powering several components thereof.

In addition to the components of the wind turbine 2 described above, the up tower section 4 of the wind turbine may include several auxiliary components, such as, a yaw system 26 on which the nacelle 16 may be positioned to pivot and orient the wind turbine in a direction of the prevailing wind current or another preferred wind direction, a pitch control unit (PCU) (not visible) situated within the hub 12 for controlling the pitch (e.g., angle of the blades with respect to the wind direction) of the blades 10, a hydraulic power system (not visible) to provide hydraulic power to various components such as brakes of the wind turbine, a cooling system (also not visible), a lightning rod 28 for protecting the wind turbine from lightning strikes, and the like. Notwithstanding the auxiliary components of the wind turbine 2 described above, it will be understood that the wind turbine 2 may include several other auxiliary components that are contemplated and considered within the scope of the present disclosure. Furthermore, a turbine control unit (TCU) 30 and a control system 32 (one or both of which may be classified as auxiliary components) may be situated within the nacelle 16 for controlling the various components of the wind turbine 2.

With respect to the down tower section 6 of the wind turbine 2, among other components, the down tower section may include a pair of generator control units (GCUs) 34 and a down tower junction box (DJB) 36 for routing and distributing power between the wind turbine and the grid. Notwithstanding the fact that in the present embodiment, a pair of the GCUs 34 has been shown, in at least some embodiments, the number of the GCUs may vary from a single unit to possibly more than two as well. In addition, several other components, such as, ladders, access doors, etc., that may be present within the down tower section 6 of the wind turbine 2 are contemplated and considered within the scope of the present disclosure.

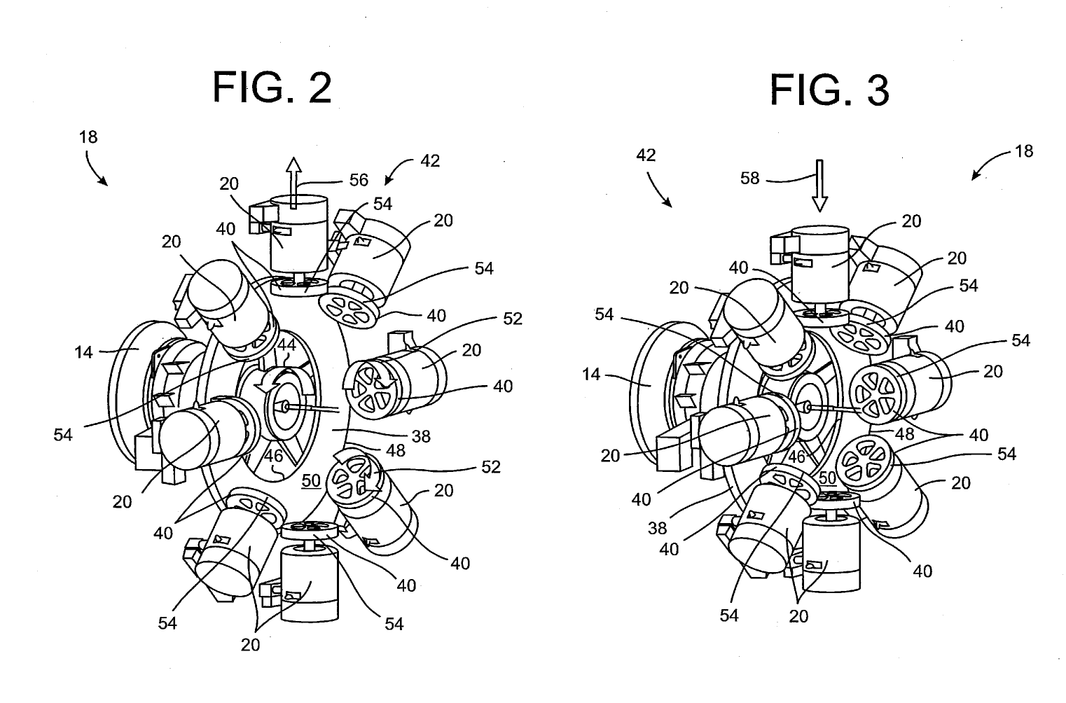

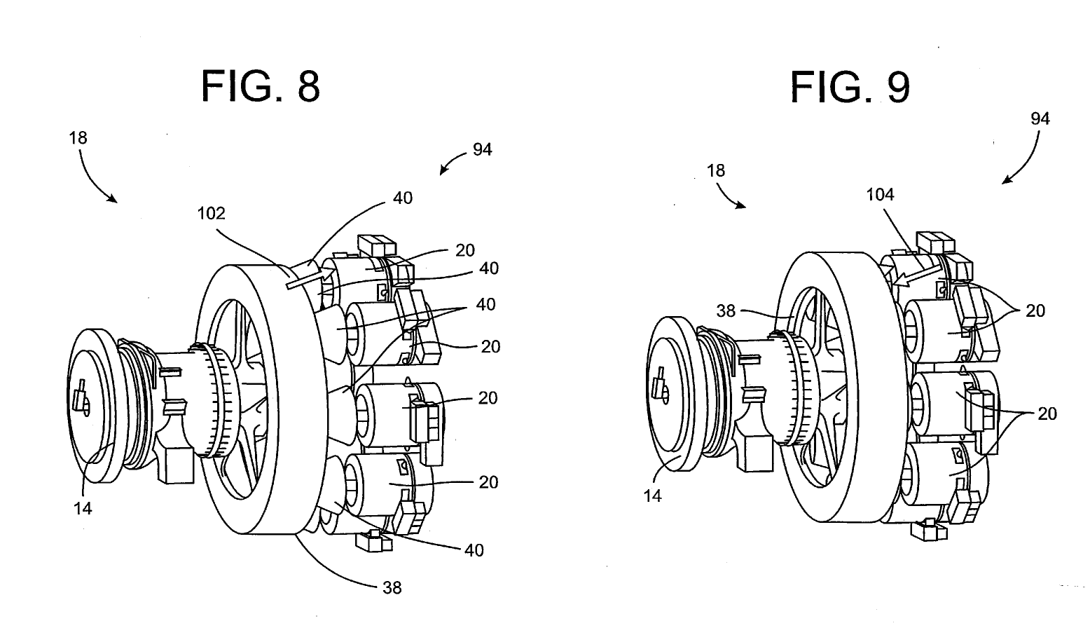

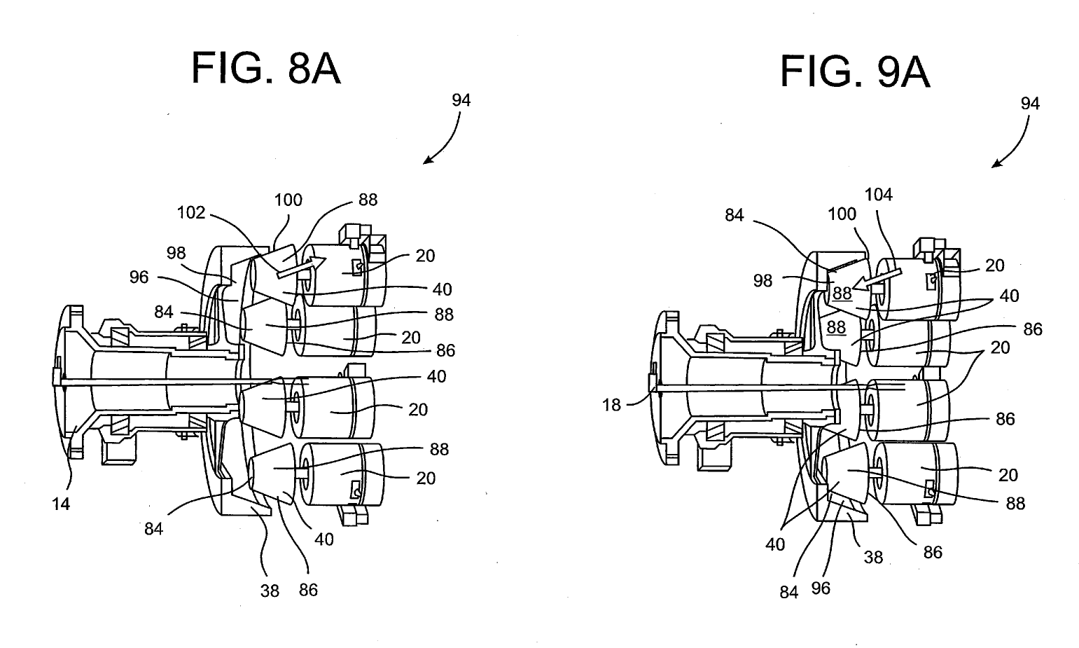

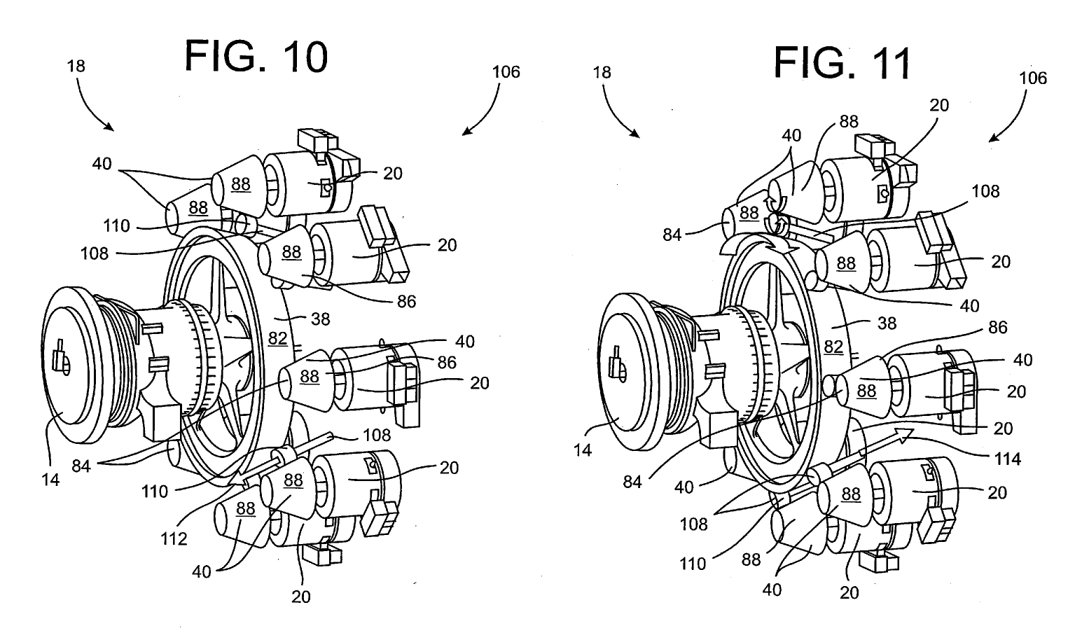

Referring now to FIGS. 2-11, several embodiments of the drive train 18 are shown, in accordance with at least some embodiments of the present disclosure. Specifically, FIGS. 2 and 3, 4 and 5, 6 and 7 show first, second, third embodiments, respectively, of the drive train 18, while FIGS. 8, 8A, 9 and 9A show a fourth embodiment of the drive train. FIGS. 10 and 11 show a fifth embodiment of the drive train 18. Referring now generally to all of FIGS. 2-11 and as shown, the drive train 18 is a friction wheel drive train and particularly, a variable speed ratio friction wheel drive train having a drive wheel (also referred to herein as a driving wheel) 38 mounted onto the main shaft 14 and driving a plurality of driven wheels 40 positioned about the drive wheel. The drive train 18 utilizes friction to transfer power from the drive wheel 38 to the driven wheels 40. Furthermore, the embodiments of FIGS. 2 to 11 show a single stage variable speed ratio speed increaser friction wheel drive train having one set of the drive wheel 38 and the driven wheels 40.

Notwithstanding the fact that in the present embodiments, the drive train 18 has been shown as being a single stage speed increaser, in at least some other embodiments, the drive train 18 may be a multi-stage variable speed ratio speed increaser that employs multiple sets of the drive wheel 38 and the driven wheels 40. For example, for a two stage speed increaser, the drive wheel 38 may drive the driven wheels 40, which in turn may be connected to another one of the drive wheel (e.g., the driven wheels may be sandwiched between two drive wheels) and that drive wheel may drive another set of driven wheels. Depending upon the number of stages of speed increase desired, the number of the stages (each stage having one set of the drive wheel and the driven wheels) of the drive wheel 38 and the driven wheels 40 may vary as well. In addition, although in the present embodiment, only a single drive wheel 38 that drives the plurality of driven wheels 40 has been shown, this is merely exemplary. In other embodiments, more than one of the drive wheel 38 driving a single or multiple number of the driven wheels 40 may be employed. Similarly, one or more of the drive wheel 38 driving a single one of the driven wheels 40 may be used as well.

Additionally, the drive wheel 38 and the driven wheels 40 may be constructed of any of a variety of commonly employed materials in friction wheels. For example, in some embodiments, one or both of the drive wheel 38 and the driven wheels 40 may be constructed of steel (e.g., polished steel or machined steel). While constructing the drive and the driven wheels 38 and 40, respectively, of steel may advantageously transmit power from the drive wheel to the driven wheels with greater efficiency, in at least some other embodiments, one or both of the drive and the driven wheels may be constructed of other materials, such as, rubber, wood or possibly plastic. In yet other embodiments, depending upon the efficiency, wheel life span, cost and power requirements that are desired, other types of materials may be employed as well for constructing one or both of the drive wheel 38 and the driven wheels 40.

With respect to the size of the drive wheel 38 and the driven wheels 40, it may vary as well, depending particularly upon the speed ratio of the drive train 18 that is desired. As stated above, the drive train 18 (e.g., the friction wheel drive train) is a variable speed ratio speed increaser friction wheel, meaning that the drive train is capable of increasing (or decreasing) the rotational speed of the rotor 8 to provide a constant output rotational speed for driving the one or more generators 20. In other words, the drive train 18 and particularly, the driven wheels 40 may be capable of supplying a constant output rotational speed, independent of the input rotational velocity of the main shaft 14 that drives the drive wheel 38. Thus, depending upon the ratio of the input rotational speed to the output rotational speed (also referred to herein as speed ratio) that is desired, the size of the drive wheel 38 and the driven wheels 40 may vary in order to provide a constant output rotational speed for a given input rotational speed. Generally speaking, by varying the effective circumference of the drive wheel 38 and the driven wheels 40 and the area (and/or location) of contact therebetween, a desired speed ratio may be obtained. The shape of the drive wheel 38 and/or the driven wheels 40 may vary as well, as described further below.

Referring still to FIGS. 2-11 in general, each of the driven wheels 40 may be further connected to one of the one or more generators 20. As shown, in the present embodiments, eight of the driven wheels 40 drive eight of the generators 20. In other embodiments, more or less than eight driven wheels and generators may be employed. As also shown, the driven wheels 40 may be arranged symmetrically about a rotational axis of the drive wheel 38 and the main shaft 14. “Symmetrical” as used herein to describe the relative positioning of the driven wheels 40 with respect to the drive wheel 38 and the main shaft 14 means that the positioning of these components creates complementary forces on the main shaft and the drive wheel that somewhat cancel one another out. Notwithstanding the symmetrical arrangement of the driven wheels 40 described above, it will be understood that such an arrangement of the driven wheels is not always required. Rather, in at least some embodiments, the driven wheels 40 may be positioned in a non-symmetrical arrangement about the drive wheel 38 and the main shaft 14.

In operation, when the drive wheel 38 is rotated by the wind turbine 2 (e.g., by the rotor 8 and the main shaft 14), and the driven wheels 40 are forced (e.g., rotated and/or translated) against the drive wheel, rotational motion from the drive wheel is transferred to the driven wheels and torque from the drive wheel is split into multiple pathways to the driven wheels. For an “X” number of the driven wheels 40 that may be employed for each one of the drive wheel 8, the torque may be split into “X” number of pathways. By splitting torque, a reduction of the overall forces on the main shaft 14 that are reacted by main shaft bearings may be achieved. Reducing forces required to be reacted by the main shaft bearings is important in ensuring the longevity of the drive train 18 and/or reducing the cost of the bearings. Furthermore, by rotating and/or translating the driven wheels 40 against the drive wheel 38, an increase or decrease in the desired speed ratio may be achieved, thereby providing a variable speed ratio speed increaser.

For example, for a desired generator speed that is about ten (10) times the speed of the rotor 8, the size of the driven wheels 40 may be selected to be nominally about ten (10) times smaller than the drive wheel 38. The nominal size of both the drive wheel 38 and the driven wheels 40 may be measured at the average diameter of the respective wheel. As the rotational speed of the rotor 8 falls below its nominal rated speed, the generator speed may begin to proportionally decrease. To mitigate the generator speed reduction, the speed ratio of the drive train 18 may be increased by translating the driven wheels 40 against the drive wheel 38, until the generator speed accelerates to its desired operating speed. Relatedly, if the rotational speed of the rotor 8 climbs above its nominal rated speed, the generator speed may begin to proportionally increase. To mitigate the generator speed increase, the speed ratio of the drive train 18 may be decreased by translating the driven wheels 40 against the drive wheel 38, until the generator speed decelerates to its desired operating speed. Thus, by translating the driven wheels 40 and the drive wheel 38 relative to one another, a constant rotational speed of the generators 20 may be achieved. Various embodiments of varying (e.g., increasing or decreasing) the speed ratio are described below in FIGS. 2-11.

Referring specifically now to FIGS. 2 and 3, a first embodiment of a variable speed ratio speed increasing friction wheel drive train 42 is shown, in accordance with at least some embodiments of the present disclosure. FIG. 2 in particular shows a method for increasing the speed ratio of the drive train 42, while FIG. 3 shows a method for decreasing the speed ratio thereof. The drive train 42 may include the drive wheel 38 mounted onto the main shaft 14 and may drive eight of the driven wheels 40, which in turn may drive eight of the generators 20. As discussed above, the number of the drive and the driven wheels 38 and 40, respectively, and the generators 20 connected thereto may vary in other embodiments.

Furthermore, the drive wheel 38 may be a flat circular disk rotating in a direction shown by an arrow 44 and having an inner wall 46 (e.g., defining an inner radius, as measured from a center of the disk), an outer wall 48 (e.g., defining an outer radius that is larger than the inner radius) and a front surface 50 extending between the inner and the outer walls. Each of the driven wheels 40, which may be smaller in radius than the drive wheel, may be rotating in a direction indicated by arrows 52. Notwithstanding the particular directions of rotation of the drive and the driven wheels 38 and 40, respectively, that has been shown, this is merely exemplary. The direction of rotation of the drive wheel 38 and the driven wheels 40 may vary in other embodiments. For example, the drive wheel 38 and the driven wheels 40 may both rotate in the same direction (clockwise or counter clockwise) or they may rotate in opposite directions as well.

In addition, the driven wheels 40 may be arranged symmetrically about the drive wheel 38 and the main shaft 14 in such a way that a rotational axis of each of the driven wheels is not coaxial with a rotational axis of the drive wheel. By virtue of arranging the driven wheels 40 non-coaxially about the drive wheel 38 and the main shaft 14, the driven wheels may be translated against the drive wheel in a manner described below to vary the contact location and the effective circumference of the drive wheel and the driven wheels to vary the speed ratio. Translation of the driven wheels 40 with respect to the drive wheel 38 may be achieved by any of variety of mechanical or electromechanical devices, such as, a hydraulic ramp, a rack and pinion, a ball screw, a slider crank, or any other actuator capable of facilitating a linear motion (in case of flat disks) and/or traversing a convex or concave path, via a curved path of motion (in case of concave or convex disks). Furthermore, as shown in FIGS. 2 and 3, the driven wheels 40 may be arranged such that a side surface 54 of each of the driven wheels 40 contacts the front surface 50 of the drive wheel 38 for translation.

In order to increase the overall speed ratio of the drive train 42, each of the driven wheels 40 (and the generators 20 connected thereto) may be translated radially outward about the front surface 50 of the drive wheel 38 in a direction shown by arrow 56 in FIG. 2. Specifically, the driven wheels 40 may be translated from the inner wall 46 defining a smaller radius on the drive wheel 38 towards the outer wall 48 defining a larger radius on the drive wheel. By virtue of translating the driven wheels radially about the front surface 50 of the drive wheel from the inner wall 46 towards the outer wall 48, the effective circumference or location of contact between the drive and the driven wheels 38 and 40, respectively, is gradually increased, which in turn increases the speed ratio of the drive train 42. The driven wheels 40 may be continuously translated towards the outer wall 48 until the desired speed ratio increase is obtained. In at least some embodiments and typically, the desired speed ratio increase may be obtained before the driven wheels 40 have translated to the absolute edge of the outer wall 48.

Relatedly, as shown in FIG. 3, in order to decrease the overall speed ratio of the drive train 42, the driven wheels 40 may be translated radially inward in a direction indicated by arrow 58 from the outer wall 48 towards the inner wall 46, thereby decreasing the effective circumference or contact location of the drive and the driven wheels. This decrease in the effective circumference may decrease the overall speed ratio of the drive train 42. The driven wheels 40 may be continuously translated from the outer wall 48 towards the inner wall 46 of the drive wheel 38 until the desired speed ratio decrease is obtained. Similar to FIG. 2, the desired decrease in speed ratio may be obtained before the driven wheels 40 reach the absolute center or the edge of the inner wall 46.

It will be understood that each of the driven wheels 40 may translate at different speeds (and different directions) and up to a different level, depending upon the output rotational speed required to maintain the output frequency of the generator 20 connected to a particular one of the drive wheel. In other words, some of the driven wheels 40 may be translated to increase the speed ratio while some of the driven wheels may be translated to decrease the speed ratio, depending upon the requirements of the generators 20 connected thereto.

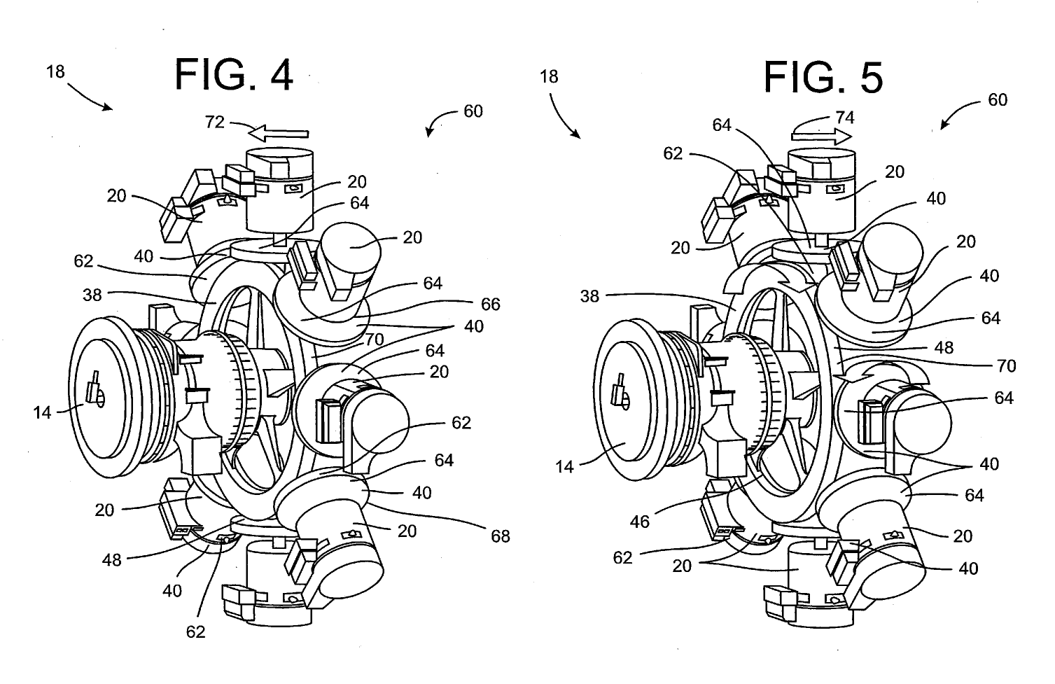

Turning now to FIGS. 4 and 5, a second embodiment of a variable speed ratio speed increasing friction wheel drive train 60 is shown, in accordance with at least some embodiments of the present disclosure. FIG. 4 in particular shows a method for increasing the speed ratio of the drive train 60, while FIG. 5 shows a method for decreasing the speed ratio thereof. To the extent that FIGS. 4 and 5 are similar to FIGS. 2 and 3, respectively, only the differences between the two embodiments will be described here. Similar to the embodiment of FIGS. 2 and 3, the driven wheels 40 may be arranged symmetrically and non-coaxially about the drive wheel 38 for translation in FIGS. 4 and 5 and rotating in the direction indicated by the arrows 44 and 52.

In contrast to the drive wheel 38 of FIGS. 2 and 3, the drive wheel of FIGS. 4 and 5 and, particularly, the front surface 50 (e.g., the portion extending between the inner and the outer walls 46 and 48, respectively) of the drive wheel may be narrower. Relatedly, in contrast to the driven wheels 40 of FIGS. 2 and 3, the driven wheels of FIGS. 4 and 5 may be flat circular disks and may have broader front and back surfaces 62 and 64, respectively, extending between an inner wall 66 (defining a smaller inner radius as measured from a center of the disk) and an outer wall 68 (defining a larger outer radius). In further contrast to FIGS. 2 and 3, the driven wheels 40 of FIGS. 4 and 5 may be positioned about the drive wheel 38 such that the front surface 62 of the drive wheels is in contact with a side surface 70 of the drive wheel (making a substantial orthogonal or ninety degree angle) for translation. Thus, while in FIGS. 2 and 3, the drive wheel 38 may be disk shaped and the driven wheels 40 may be more wheel shaped, in FIGS. 4 and 5, the drive wheel may be more wheel shaped and the driven wheels may be disk shaped.

Furthermore, the driven wheels 40 may be translated with respect to the drive wheel 38 between the inner and the outer walls 66 and 68, respectively, of the driven wheels to increase or decrease the speed ratio of the drive train 60. For example, and as shown in FIG. 4, the driven wheels 40 may be translated axially upwind in a direction shown by arrow 72 from the outer wall 68 towards the inner wall 66 such that the contact location from the drive wheel 38 to the driven wheels is varied from the larger outer radius of the outer wall along the driven wheels to the smaller inner radius of the inner wall along the driven wheels to increase the overall speed ratio of the drive train 60. Relatedly, as shown in FIG. 5, the driven wheels 40 may be translated axially downwind in a direction shown by arrow 74 from the smaller radius of the inner wall 66 towards the larger radius of the outer wall 68 until the desired decrease in the speed ratio is obtained. Also similar to the drive train 42, it will be understood that each of the driven wheels 40 may be translated at different speeds, different directions and up to different levels in the drive train 62. In addition, although the above embodiments of FIGS. 4 and 5 have been described with the driven wheels 40 translating against the drive wheel 38 that is in a fixed position, in at least some embodiments, the drive wheel may be translated in upwind or downwind directions against the driven wheels, which may be fixed, to change the contact radius of the drive wheel on the driven wheels to vary the speed ratio.

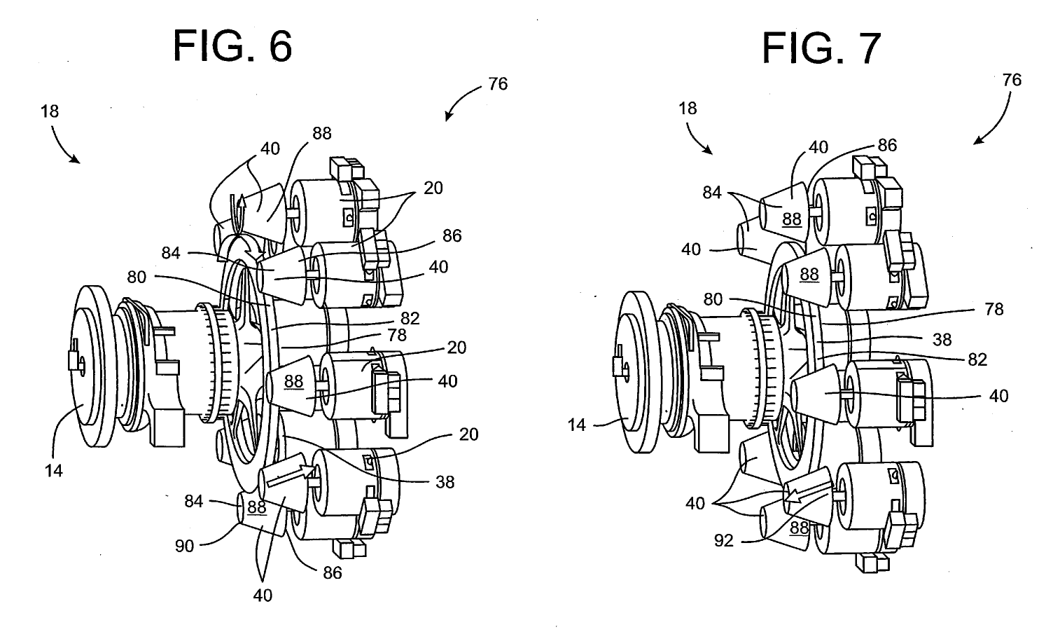

Turning now to FIGS. 6 and 7, these FIGS. show a third embodiment of a variable speed ratio speed increasing friction wheel drive train 76, in accordance with at least some embodiments of the present disclosure. FIG. 6 in particular shows a method for increasing the speed ratio of the drive train 76, while FIG. 7 shows a method for decreasing the speed ratio thereof. As shown, the drive train 76 may include the drive wheel 38 mounted onto the main shaft 14 and driving a plurality of driven wheels 40. In contrast to the drive and the driven wheels 38 and 40, respectively, of FIGS. 2-5, which were circular in shape, the drive and the driven wheels of FIGS. 6 and 7 (and also of FIGS. 8-11) may be conical in shape. The conical configuration of the drive wheel 38 and the driven wheels 40 is described below.

The drive wheel 38 in FIGS. 6 and 7 may be a conical external friction wheel having a smaller outer radius 78 (as measured from a center of the wheel) and a larger outer radius 80 defining an outer sloping (or conical) surface 82 therebetween. Each of the driven wheels 40 may be conical external friction wheels as well having a smaller outer radius 84 and a larger outer radius 86 defining an outer sloping (or conical) surface 88 therebetween. The conical drive wheel 38 and the driven wheels 40 may be configured such that the slope of the outer sloping surface 82 of the drive wheel matches the slope of the outer sloping surface 88 of the driven wheels. Furthermore, the driven wheels 40 may be arranged about the drive wheel 38 and the main shaft 14 in a symmetrical fashion such that a rotational axis of the drive wheel is parallel to a rotational axis of each of the driven wheels, although this need not always be the case.

The driven wheels 40 may further be arranged such that the outer sloping surface 88 of the driven wheels contacts the outer sloping surface 82 of the driving wheels, which may be translated axially about the drive wheel. As shown in FIG. 6, the driven wheels 40 may be translated axially downwind in a direction indicated by arrow 90 along a line of action that is consistent with the slope (or cone) angles of the drive and the driven wheels 38 and 40, respectively, such that the contact location from the drive wheel to the driven wheels is varied from the large outer radius 86 along the driven wheels to the smaller outer radius 84 along the driven wheels to increase the overall speed ratio of the drive train 76. Relatedly, as shown in FIG. 7, the driven wheels 40 may be translated upwind along a direction indicated by arrow 92 along a line of action such that the contact location between the drive wheel 38 and the driven wheels vary from the smaller outer radius 84 of the driven wheels to the larger outer radius 86 of the driven wheels to decrease the overall speed ratio of the drive train 76.

Referring now to FIGS. 8, 8A, 9 and 9A, a fourth embodiment of a variable speed ratio speed increasing friction wheel drive train 94, in accordance with at least some embodiments of the present disclosure. FIGS. 8 and 8A in particular show a method for increasing the speed ratio of the drive train 94, while FIGS. 9 and 9A show a method for decreasing the speed ratio thereof. FIGS. 8A and 9A show partial cross-sectional views of FIGS. 8 and 9, respectively. To the extent that FIGS. 8, 8A, 9 and 9A are similar to the embodiment of FIGS. 6 and 7, only the differences between the two embodiments are described here. Similar to the drive train 76 of FIGS. 6 and 7, the drive train 94 shows a conical configuration of the drive wheel 38 and the driven wheels 40, which may be arranged about the drive wheel such that the rotational axis of the drive wheel is parallel (although this may vary) to the rotational axes of the driven wheels. However, in contrast to the drive train 76 in which the driven wheels 40 translate along the outer sloping surface 82 of the drive wheel 38, in the drive train 94, the driven wheels translate along an inner sloping surface 96 of the drive wheel.

Accordingly and as shown in the cross-sectional views of FIGS. 8A and 9A, the drive wheel 38 of the drive train 94 may be a conical internal friction wheel having a smaller inner radius 98 and a larger inner radius 100 defining the inner sloping surface 96. The width of the drive wheel 38 of the drive train 94 may be broader (but, the width of the contact area may still be the same) than the width of the drive wheel of the drive train 76. The driven wheels 40 of the drive train 94 may be similar (e.g., conical external friction wheels) to the driven wheels 40 of the drive train 76 having the smaller outer radius 84, the larger outer radius 86 and the outer sloping surface 88. The slope of the inner sloping surface 96 of the drive wheel 38 may match the slope of the outer sloping surface 88 of the driven wheels. As mentioned above, the slopes, as well as the height of the drive and the driven wheels 38 and 40, respectively, may be determined by the speed ratio of the drive train 94 that is desired. In addition, the driven wheels 40 may be positioned with respect to the drive wheel 38 such that the outer sloping surface 88 of the driven wheels contacts the inner sloping surface 96 of the drive wheel for translation.

In order to increase the overall speed ratio of the drive train 94, as shown in FIG. 8, the driven wheels 40 may be translated downwind in a direction indicated by arrow 102 along a line of action that is consistent with the slope or cone angles of the drive and the driven wheels 38 and 40, respectively, such that the contact location from the drive wheel to the driven wheels is varied from the large outer radius 86 along the driven wheels to the smaller outer radius 84 along the driven wheels. Relatedly, to decrease the overall speed ratio of the drive train 94, as shown in FIG. 9, the driven wheels 40 may be translated upwind in a direction indicated by arrow 104 such that the contact location of the drive wheels vary from the smaller outer radius 84 towards to the larger outer radius 86 along the inner sloping surface 96 of the drive wheel 38.

As with the embodiments of FIGS. 2-5, the driven wheels 40 of FIGS. 6-9 may translate at different speeds, up to different levels and in different directions depending upon the rotational speed required by the generators 20 connected thereto.

Turning now to FIGS. 10 and 11, a fifth embodiment of a variable speed ratio speed increasing friction wheel drive train 106 is shown, in accordance with at least some embodiments of the present disclosure. FIG. 10 in particular shows a method for increasing the speed ratio of the drive train 106, while FIG. 11 shows a method for decreasing the speed ratio thereof. Furthermore, the drive train 106 is similar to the drive train 76 of FIGS. 6 and 7 in that the drive train 106 employs a conical external friction wheel for the drive wheel 38 and conical external friction wheels for the driven wheels 40. However, in contrast to the drive train 76 in which the driven wheels 40 and the generators 20 connected thereto translate directly against the drive wheel 38, in the drive train 106, the drive wheel translates against the driven wheels through a translatable idler wheel 108.

By virtue of utilizing the translatable idler wheel 108 between each of the driven wheels 40 and the drive wheel 38, only the translatable idler wheel needs to translate. The driven wheels 40 and the generators 20 may remain stationary. Advantageously, by avoiding the need to translate the generators 20, the design and complexity of the generators (and the extra cabling used to account for the translation) may be reduced. It will be understood that while the translatable idler wheels 108 have been shown with respect to the embodiment of FIGS. 6 and 7, similar translatable idler wheels may be employed with any of the aforementioned embodiments of FIGS. 2-5 and 8-9.

Thus, the outer sloping surface 88 of the driven wheels 40 contacts an outside diameter 110 of one of the translatable idler wheels 108, which in turn contacts the outer sloping surface 82 of the drive wheel 38. As shown in FIG. 10, the translatable idler wheels 108 may translate along the outer sloping surface 88 of the driven wheels 40 upwind in a direction indicated by arrow 112 from the larger outer radius 86 to the smaller outer radius 84 of the driven wheels to increase the speed ratio. Specifically, as the translatable idler wheels 108 translate along the outer sloping surface 88 of the driven wheels 40, it also translates along the outer sloping surface 82 of the drive wheel 38. This translation occurs along a line of action that is consistent with the cone angles of the driving and driven wheels 38 and 40, respectively, such that the contact location from the driving wheel to the driven wheels is varied from the larger outer radius 86 along the driven wheels towards the smaller outer radius 84 along the driven wheels and from the smaller outer radius 78 of the driving wheel to the larger outer radius 80 of the driving wheel to increase the overall speed ratio of the drive train 106.

Relatedly, as shown in FIG. 11, the translatable idler wheels 108 may translate downwind in a direction shown by arrow 114 along a line of action that is consistent with the cone angles of the driving and driven wheels 38 and 40, respectively, such that the contact location from the driving wheel to the driven wheels is varied from the smaller outer radius 84 along the driven wheels towards the larger outer radius 86 along the driven wheels and from the larger outer radius 80 of the driving wheel to the smaller outer radius 78 of the driving wheel to decrease the overall speed ratio of the drive train 106. Again, each of the translatable idler wheels 108 may translate at different speeds, in different directions and up to different levels to either increase or decrease the speed ratio of the drive train 106.

Thus, the present disclosure sets forth a variable speed ratio friction wheel speed increaser drive train that employs at least one drive wheel and at least one driven wheel to provide a constant output rotational speed independent of the input rotational speed of the rotor of the wind turbine. Motion from the at least one drive wheel is transmitted to the at least one driven wheel through frictional forces. Furthermore, the at least one driven wheels may be translated along a surface of the at least one drive wheels in order to vary the speed ratio. Although the above embodiments have been described with the at least one driven wheels translating against a fixed one of the at least one drive wheel, in at least some embodiments, the at least one driven wheels may be fixed in position and the at least one drive wheel may translate against the fixed ones of the at least one driven wheels to change the speed ratio.

By providing a variable speed ratio drive train, such as the one described above, use of a synchronous generator design within a wind turbine may be facilitated. This variable speed ratio speed increaser may produce a constant output rotational velocity, independent of the wind turbine shaft rotational velocity to regulate the output frequency and power of the generators connected to the a least one driven wheels. The variable speed ratio speed increaser friction wheel drive train may, thus, allow a wind turbine manufacturer to eliminate the expensive power electronics that are required with variable speed generators that are driven by a constant ratio speed increaser drive trains.

While only certain embodiments have been set forth, alternatives and modifications will be apparent from the above description to those skilled in the art. These and other alternatives are considered equivalents and within the spirit and scope of this disclosure and the appended claims.

We claim:

1. A drive train for a wind turbine, the drive train comprising:
at least one drive wheel adapted to receive mechanical energy from a main shaft of a wind turbine and capable of rotating at a variable input rotational speed; and
at least one driven wheel in at least indirect contact with the at least one drive wheel, the at least one driven wheel capable of at least indirectly translating against the at least one drive wheel to vary a speed ratio of the drive train to provide a constant output rotational speed.

2. The drive train of claim 1, wherein the at least one drive wheel comprises one drive wheel and the at least one driven wheel comprises a plurality of driven wheels capable of translating at least indirectly against the one drive wheel.

3. The drive train of claim 1, wherein the at least one drive wheel is larger in size than each of the at least one driven wheel.

4. The drive train of claim 1, wherein the at least one drive wheel is substantially circular disk shaped having an inner wall defining a smaller inner radius, an outer wall defining a larger outer radius and a front surface connecting the inner and the outer walls, and the at least one driven wheel comprises a side surface in contact with the front surface of the at least one drive wheel, a rotational axis of the at least one driven wheel being non-coaxial with a rotational axis of the at least one drive wheel and the at least one driven wheel capable of translating against the front surface between the inner and the outer walls of the at least one drive wheel to vary the speed ratio of the drive train.

5. The drive train of claim 4, wherein the at least one driven wheel translates radially from the smaller inner radius towards the larger outer radius of the at least one drive wheel for increasing the speed ratio of the drive train and the at least one driven wheel translates radially from the larger outer radius towards the smaller inner radius of the at least one drive wheel for decreasing the speed ratio of the drive train.

6. The drive train of claim 1, wherein the at least one drive wheel comprises a side surface in contact with a front surface of the at least one driven wheel, the at least one driven wheel being substantially circular disk shaped having an inner wall defining a smaller inner radius and an outer wall defining a larger outer radius, the front surface of the at least one driven wheel extending between the inner and the outer walls and a rotational axis of the at least one driven wheel being non-coaxial with a rotational axis of the at least one drive wheel, the at least one driven wheel capable of translating between the inner and the outer walls thereof against the side surface of the at least one drive wheel to vary the speed ratio of the drive train.

7. The drive train of claim 6, wherein the at least one driven wheel translates axially from the larger outer radius towards the smaller inner radius thereof to increase the speed ratio of the drive train and the at least one driven wheel translates axially from the smaller inner radius towards the larger outer radius to decrease the speed ratio of the drive train.

8. The drive train of claim 1, wherein the at least one drive wheel is a conical external friction wheel having an outer sloping surface and the at least one driven wheel is a conical external friction wheel having a smaller outer radius and a larger outer radius defining an outer sloping surface, the outer sloping surface of the at least one drive wheel in contact with and matching the outer sloping surface of the at least one driven wheel, a rotational axis of the at least one driven wheel being coaxial with a rotational axis of the at least drive wheel and the at least one driven wheel capable of translating between the smaller and the larger outer radii thereof to vary the speed ratio of the drive train.

9. The drive train of claim 8, wherein the at least one driven wheel translates from the larger outer radius towards the smaller outer radius thereof to increase the speed ratio of the drive train and the at least one driven wheel translates from the smaller outer radius towards the larger outer radius to decrease the speed ratio of the drive train.

10. The drive train of claim 1, wherein the at least one drive wheel is a conical internal friction wheel having an inner sloping surface and the at least one driven wheel is a conical external friction wheel having a smaller outer radius and a larger outer radius defining an outer sloping surface, the inner sloping surface of the at least one drive wheel in contact with and matching the outer sloping surface of the at least one driven wheel, a rotational axis of the at least one driven wheel being coaxial with a rotational axis of the at least drive wheel and the at least one driven wheel capable of translating between the smaller and the larger outer radii thereof to vary the speed ratio of the drive train.

11. The drive train of claim 10, wherein the at least one driven wheel translates from the larger outer radius towards the smaller outer radius thereof to increase the speed ratio of the drive train and the at least one driven wheel translates from the smaller outer radius towards the larger outer radius to decrease the speed ratio of the drive train.

12. The drive train of claim 1, further comprising at least one translatable idler wheel positioned between and in contact with the at least one drive wheel and the at least one driven wheel, the at least one translatable idler wheel capable of translating against a surface of the at least one drive wheel to vary the speed ratio of the drive train.

13. A wind turbine, comprising:
a hub;
a plurality of blades radially extending from the hub;
a main shaft rotating with the hub; and
a drive train comprising (a) at least one drive wheel mounted to the main shaft and rotating at a variable input rotational speed; and (b) at least one driven wheel in at least indirect contact with the at least one drive wheel, the at least one driven wheel capable of providing a constant output rotational speed by varying a speed ratio of the drive train.

14. The wind turbine of claim 13, further comprising at least one generator connected at least indirectly to the at least one driven wheel, the constant output rotational speed regulating an output frequency of the at least one generator.

15. The wind turbine of claim 13, wherein the speed ratio of the drive train is varied by translating the at least one driven wheel at least indirectly against a surface of the at least one drive wheel to change a contact location therebetween, the change in contact location varying the speed ratio of the drive train.

16. The wind turbine of claim 13, wherein the drive train is a variable speed ratio speed increaser friction wheel drive train.

17. A method of varying a speed ratio of a drive train for a wind turbine, the method comprising:
providing a drive train having (a) at least one drive wheel mounted to a main shaft of a wind turbine and rotating at a variable input rotational speed; and (b) at least one driven wheel in at least indirect contact with the at least one drive wheel, the at least one driven wheel capable of providing a constant output rotational speed;
translating the at least one driven wheel at least indirectly against a surface of the at least one drive wheel; and
changing a contact location between the at least one drive wheel and the at least one driven wheel during the translating step to vary the speed ratio of the drive train.

18. The method of claim 17, wherein each one of the at least one driven wheel translates at a different rate and in a different direction against the at least one drive wheel.

19. The method of claim 17, wherein the at least one driven wheel is a conical external friction wheel having a smaller outer radius, a larger outer radius and an outer sloping surface extending between the smaller and the larger outer radii and the at least one driven wheel translates from the larger outer radius towards the smaller outer radius thereof against a sloping surface of the at least one drive wheel to increase the speed ratio of the drive train and the at least one driven wheel translates from the smaller outer radius towards the larger outer radius thereof against the sloping surface of the at least one drive wheel to decrease the speed ratio of the drive train.

20. The method of claim 17, further comprising transmitting motion from the at least one drive wheel to the at least driven wheel by frictional forces.
